(19) United States
(12) Patent Application Publication
(10) Pub. No.: US 2018/0060348 A1
(43) Pub. Date: Mar. 1, 2018

(54) Method for Replication of Objects in a Cloud Object Store

(71) Applicant: StoreReduce, Sunnyvale, CA (US)

(72) Inventors: Tyler Wayne Power, Canterbury (NZ); Mark Alexander Hugh Emberson, Glebe (AU); Mark Leslie Cox, Christchurch (NZ)

(73) Assignee: StoreReduce, Sunnyvale, CA (US)

(21) Appl. No.: 15/673,998

(22) Filed: Aug. 10, 2017

Related U.S. Application Data
(63) Continuation-in-part of application No. 15/600,641, filed on May 19, 2017.
Application No. 15/600,641 is a continuation-in-part of application No. 15/298,897, filed on Oct. 20, 2016.
(60) Provisional application No. 62/373,328, filed on Aug. 10, 2016.
(60) Provisional application No. 62/339,090, filed on May 20, 2016.
(60) Provisional application No. 62/249,885, filed on Nov. 2, 2015.

(51) Int. Cl. G06F 17/30

(52) U.S. Cl. CPC G06F 17/30174; G06F 17/30097; G06F 17/30212

(57) ABSTRACT

A data replication system and process is disclosed. A device receives files respectively via a network from a remotely disposed computing device and partitions the received files into data objects. The device creates hash values for the first data objects and stores the data objects on remotely disposed storage systems at location addresses. The first device stores in records of a storage table, for each of the data objects, the hash values and corresponding location addresses. The device receives an indication to replicate a portion of the stored data objects and replicates the stored data objects by copying the indicated data objects stored on the first remotely located storage system to the second remotely located storage system, and after replicating the indicated data objects, copies or recreates the one or more hash values and the one or more location addresses and the one or more key-to-location (e.g. file) records corresponding to the replicated data objects in a second storage table on the second remotely located storage system.

### PRIORITY AND RELATED APPLICATIONS

This application claims the benefit of U.S. provisional application No. 62/373,328, filed Aug. 10, 2016; is a continuation-in-part of U.S. patent application Ser. No. 15/600,641, filed May 19, 2017, which is a continuation-in-part of U.S. patent application Ser. No. 15/298,897, filed Oct. 20, 2016, which claims the benefit of U.S. provisional application No. 62/373,328, filed Aug. 10, 2016, U.S. provisional application No. 62/339,090 filed May 20, 2016, and U.S. provisional application No. 62/249,885 filed Nov. 2, 2015; the contents of which are hereby incorporated by reference.

### TECHNICAL FIELD

These claimed embodiments relate to a method for replicating stored de-duplicated objects and more particularly to using an intermediary data deduplication device to replicate data objects stored in a cloud storage device via a network.

### BACKGROUND OF THE INVENTION

A data storage system using an intermediary networked device to replicate stored deduplicated data objects on a remotely located object storage device(s) is disclosed.

### SUMMARY OF THE INVENTION

A processing device to replicate files stored on segregated remotely disposed computing devices. The device receives files via a network from a remotely disposed computing device and partitions the received files into data objects. Hash values are created for the data objects, and stored on a first remotely disposed storage system at location addresses. For each of the data objects, the hash values and the location addresses are stored in one or more records of a first storage table. In response to an indication to replicate at least a portion of the stored data objects onto a second remotely disposed storage system, the portion of the received data objects are replicated onto the second remotely disposed storage system by a) copying at least a portion of the data objects stored on the first remotely located storage system to the second remotely located storage system, and optionally b) after replicating the one or more data objects, copies or recreates the one or more hash values and the one or more location addresses and the one or more key-to-location (e.g. file) records corresponding to the replicated data objects in a second storage table on the second remotely located storage system.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a simplified schematic diagram of a deduplication storage system and replication system;

FIG. 2 is a simplified schematic and flow diagram of a storage system in which a client application on a client device communicates through an application program interface (API) directly connected to a cloud object store;

FIG. 3 is a simplified schematic diagram and flow diagram of a deduplication storage system and replication system in which a client application communicates via a network to an application program interface (API) at an intermediary computing device, and then stores data via a network to a cloud object store;

FIG. 4 is a simplified schematic diagram of an intermediary computing device shown in FIG. 3;

FIG. 5 is a flow chart of a process for storing and deduplicating data executed by the intermediary computing device shown in FIG. 3;

FIG. 6 is a flow diagram illustrating the process for storing de-duplicated data;

FIG. 7 is a flow diagram illustrating the process for storing de-duplicated data executed on the client device of FIG. 3;

FIG. 8 is a data diagram illustrating how data is partitioned into data objects for storage;

FIG. 9 is a data diagram illustrating how the partitioned data objects are aggregated in to aggregate data objects for storage;

FIG. 10 is a data diagram illustrating a relation between a hash and the data objects that are stored in object storage;

FIG. 11 is a data diagram illustrating the file or object table which maps file or object names to the location addresses where the files are stored.

FIG. 12 is a flow chart of a process for writing files to new data objects executed by the intermediary computing device shown in FIG. 3;

FIG. 13 is a flow chart of a process for replicating data objects in a cloud object store with the intermediary computing device shown in FIG. 3;

FIG. 14 is a flow chart of an exemplary process for defining the “replication window” referenced in FIG. 13, block 1303;

FIG. 15-17 are simplified flow diagrams illustrating scenarios for replication between object stores; and

FIG. 18 is a flow diagram of an example of replicating data objects that contain references to other data objects.

### DETAILED DESCRIPTION

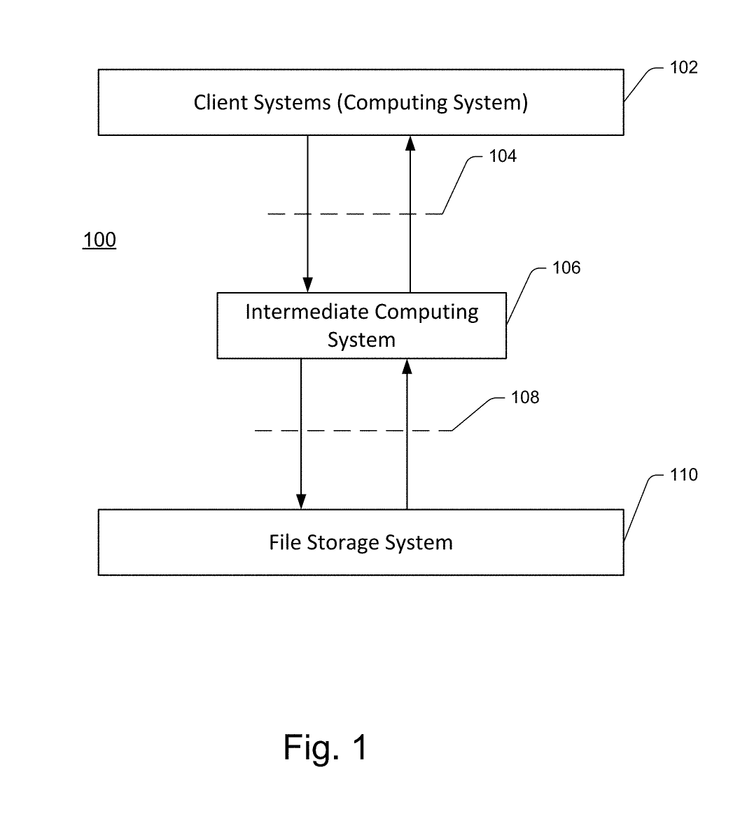

Referring to FIG. 1, there is shown a deduplication storage system 100. Storage system 100 includes a client system 102, coupled via network 104 to Intermediate Computing system 106. Intermediate computing system 106 is coupled via network 108 to remotely located File Storage system 110.

Client system 102 transmits files to intermediate computing system 106 via network 104. Intermediate computing system 106 includes a process for storing the received files on file storage system 110 in a way that reduces duplication of data within the files when stored on file storage system 110.

Client system 102 transmits requests via network 104 to intermediate computing system 106 for files stored on file storage system 110. Intermediate computing system responds to the requests by obtaining the deduplicated data on file storage system 110, reassembling the deduplicated data objects to recreate the original file data, and transmits the obtained data to client system 100. A data objects (which me be replicated) may include, but is not limited to, unique file data, metadata pertaining to the file data and replication of files, user account information, directory information, access control information, security control information, garbage collection information, file cloning information, and references to other data objects.

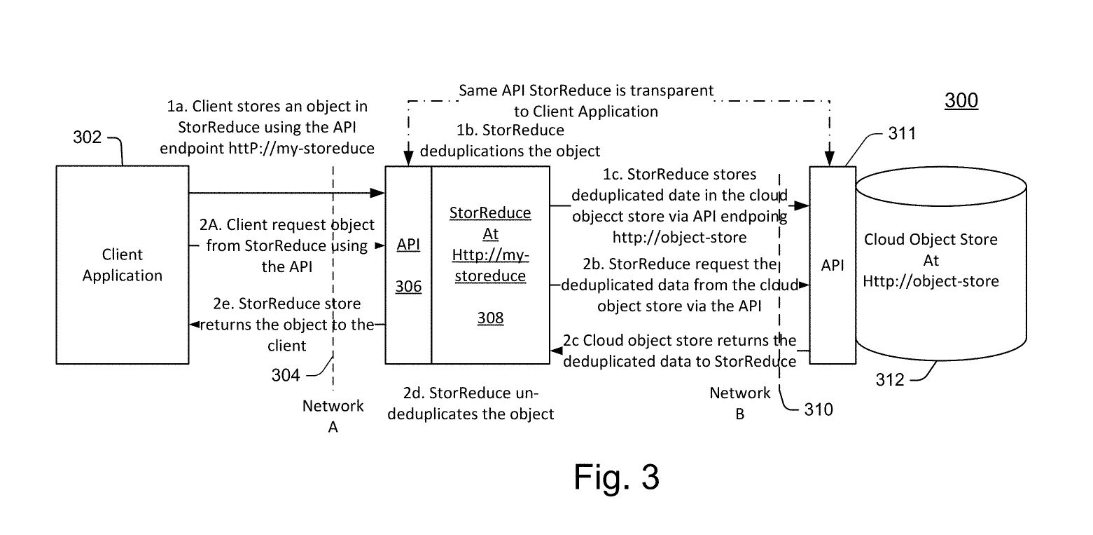

In one implementation, Intermediate Computing system 106 may be a server that acts as an intermediary between client system 102 and file storage system 110, such as a cloud object store, both implementing and making use of an object store interface (e.g. 311 in FIG. 3). The server 106 can transparently intermediate to provide the ability to deduplicate, rehydrate and replicate data, without requiring modification to either client software or the Cloud Object Store 110 being used.

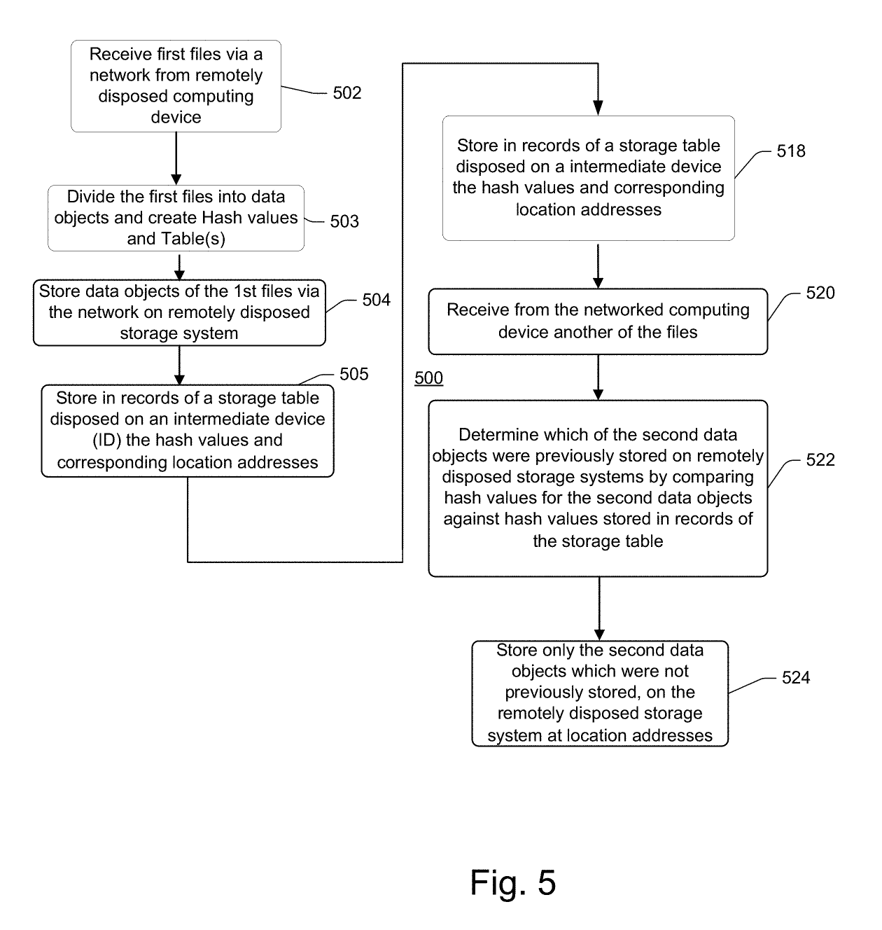

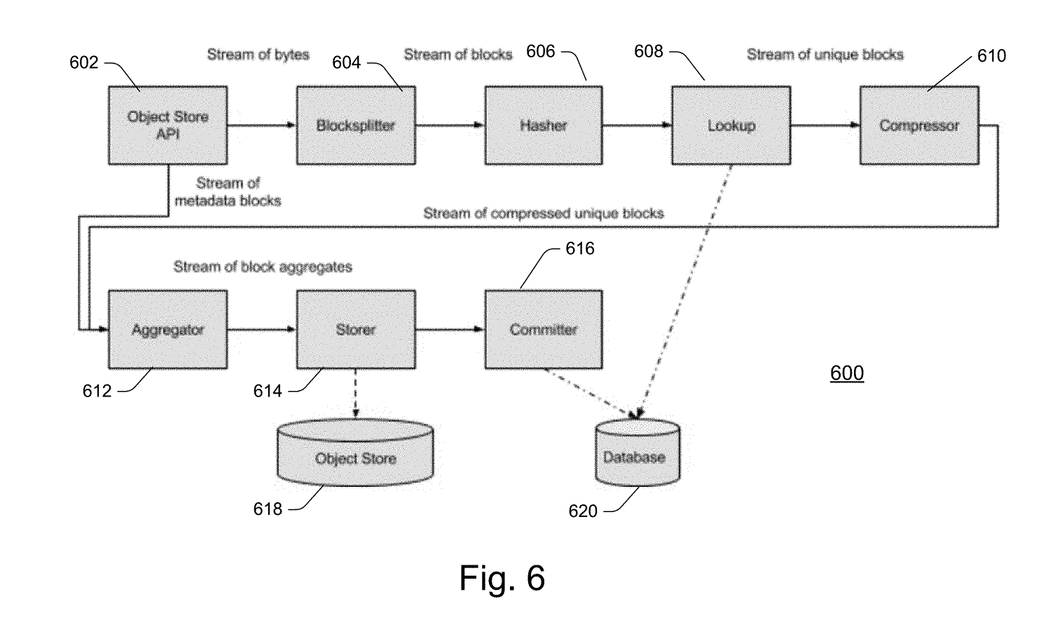

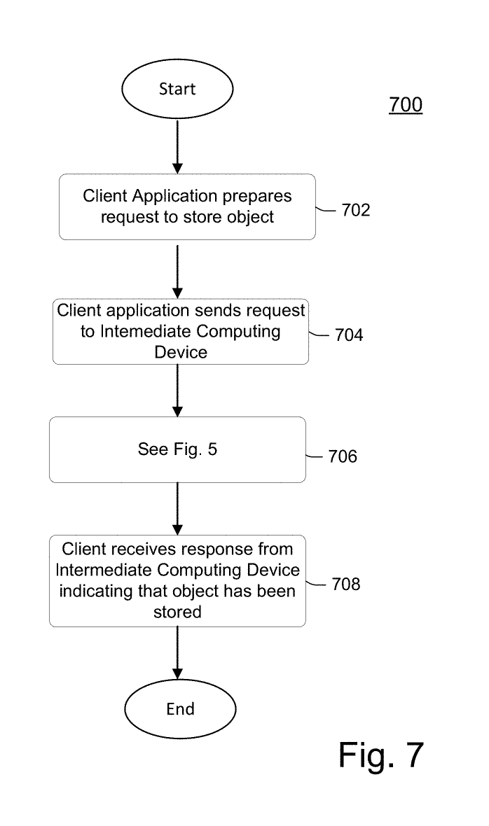

Data to be replicated is sent to the server 106 via the cloud object store interface 306, in the form of files. Each file can be referenced using a key, and the set of all possible keys is referred to herein as a key namespace. The data for each of the files is broken into data objects, and the hash of each data object and its location is recorded in an index (as described herein in FIG. 5). The data objects are then stored in the Cloud Object Store 110. The data can be deduplicated before being stored, so that only unique data objects are stored in the Cloud Object Store.

After files have been uploaded to server 106 and stored in object store 110, the corresponding data objects can be replicated. A replication operation creates a copy (a replica) of a subset of one or more of the data objects, and stores the copied data objects on the second Object Store. This operation can be repeated to make multiple replicas of any set of data objects.

Optionally, the files made up of data contained within the replicated data objects may be made available in a second location by copying or recreating the index information for those data objects to a storage table in the second location. Both the original and the replicated files have the same key and each refers to its own copy of the underlying data objects in its respective object store.

The effect of this is to be able to make any number of copies (replicas) of the data that may be created, modified and deleted on any number of cloud object storage systems.

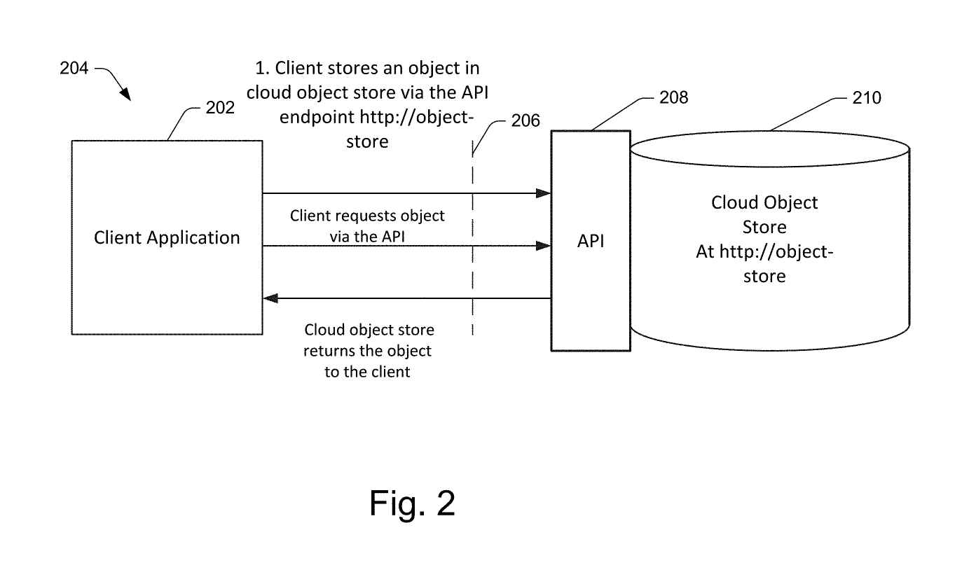

Referring to FIG. 2, a cloud object storage system 200 that includes a client application 202 on a client device 204 that communicates via a network 206 through an application program interface (API) 208 directly connected to a cloud object store 210.

Referring to FIG. 3, there is shown a deduplication storage system 300 including a client application 302 that communicates data via a network 304 to an application program interface (API) 306 at an intermediary computing device 308, and then stores the data (such as by using a block splitting algorithm as described in U.S. Patent Number U.S. Pat. No. 5,990,810, the content of which is hereby incorporated by reference) via a network 310 and API 311 on a remotely disposed computing device 312 such as a cloud object store system that may typically be administered by an object store service.

Exemplary Networks 304 and 310 include, but is not limited to, a Local Area Network, an Ethernet Wide Area Network, an Internet Wireless Local Area Network, an 802.11g standard network, a WiFi network (technology for wireless local area networking with devices based on the IEEE 802.11 standards), a Wireless Wide Area Network running protocols such as TCP (Transmission Control Protocol), UDP (User Datagram Protocol), IP (Internet Protocol), GSM (Global System for Mobile communication), WiMAX (Worldwide Interoperability for Microwave Access), LTE (Long Term evolution standard for high speed wireless communication), HDLC (High level data link control), Frame Relay and ATM (Asynchronous Transfer Mode).

Examples of the intermediary computing device 308, includes, but is not limited to, a Physical Server, a personal computing device, a Virtual Server, a Virtual Private Server, a Network Appliance, and a Router/Firewall.

Exemplary remotely disposed computing device 312 may include, but is not limited to, a Network Fileserver, an Object Store, a cloud object store, an Object Store Service, a Network Attached device, a Web server with or without WebDAV (Web Distributed Authoring and Versioning).

Examples of the cloud object store include, but are not limited to, IBM Cloud Object Store, OpenStack Swift (object storage system provided under the Apache 2 open source license), EMC Atmos (cloud storage services platform developed by EMC Corporation), Cloudian HyperStore (a cloud-based storage service based on Cloudian's HyperStore object storage), Scality RING from Scality of San Francisco, Calif., Hitachi Content Platform, and HGST Active Archive by Western Digital Corporation. Examples of the object store service include, but are not limited to, Amazon® S3, Microsoft® Azure Blob Service, Google® Cloud Storage, and Rackspace® Cloud Files.

During operation Client application 302 transmits a file via network 304 for storage by providing an API endpoint (such as http://my-storereduce. com) 306 corresponding to a network address of the intermediary device 308. The intermediary device 308 then deduplicates the file as described herein. The intermediary device 308 then stores the de-duplicated data on the remotely disposed computing device 312 via API endpoint 311. In one exemplary implementation, the API endpoint 306 on the intermediary device is virtually identical to the API endpoint 311 on the remotely disposed computing device 312.

If client application needs to retrieve stored file, client application 302 transmits a request for the file to the API endpoint 306. The intermediary device 308 responds to the request by requesting the deduplicated data objects from remotely disposed computing device 312 via API endpoint 311. The cloud object store 312 and API endpoint 311 accommodate the request by returning the deduplicated data objects to the intermediate device 308, that is then un-deduplicated, or re-hydrated, by the intermediate device 308. The intermediate device 308 via API 306 returns the file to client application 302.

In one implementation, device 308 and a cloud object store is present on device 312 that present the same API to the network. In one implementation, the client application 302 uses the same set of operations for storing and retrieving objects. Preferable the intermediate device 308 is transparent to the client application. The client application 302 does not need to be provided an indication that the intermediate device 308 is present. When migrating from a system without the intermediate processing device 308 to a system with the intermediate processing device, the only change for the client application 302 is that the location of the endpoint of where it stores files has changed in its configuration (e.g., from http://objectstore.com to http://mystorreduce.com). The location of the intermediate processing device can be disposed physically close to the client application or physically close to the cloud object store as the amount of data crossing Network 304 should be much greater than the amount of data crossing Network 310.

### Example Computing Device Architecture

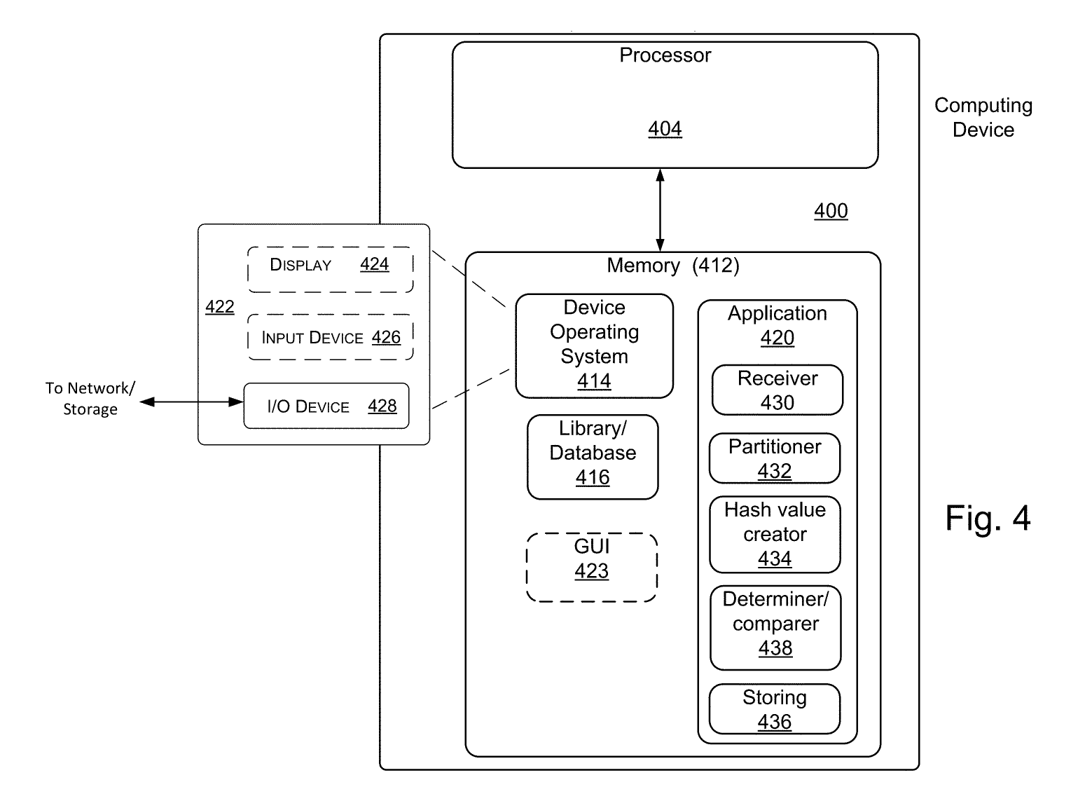

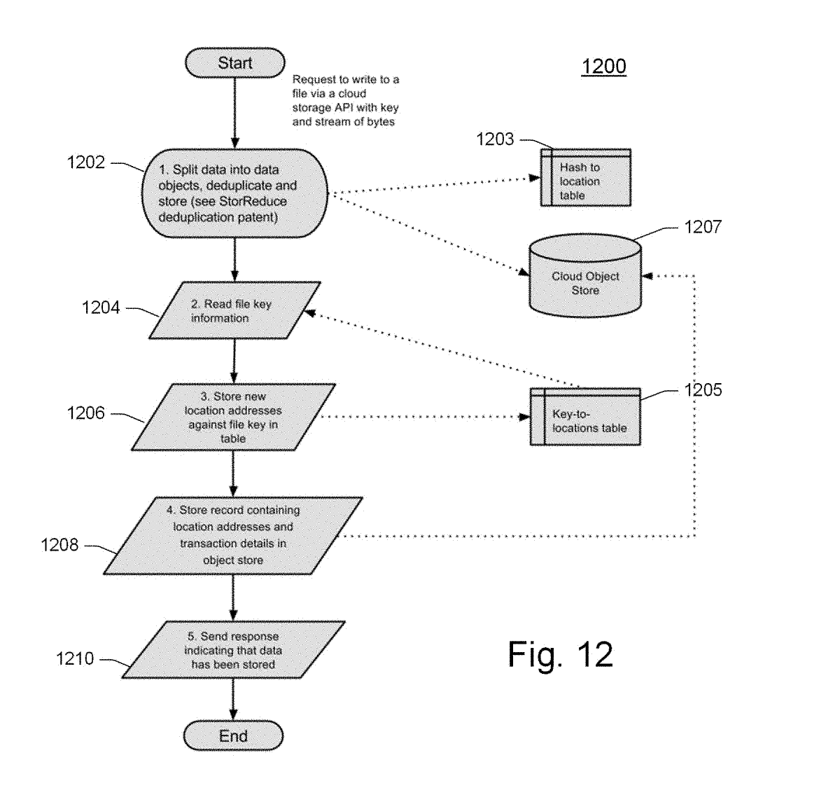

In FIG. 4 are illustrated selected modules in computing device 400 using processes 500 and 600 shown in FIGS. 5-6 and processes 1200, 1300 and 1400 shown in FIGS. 12, 13 and 14, respectively to store deduplicated data objects, and to replicate stored data objects to other remotely disposed storage systems. Computing device 400 (such as intermediary computing device 308 shown in FIG. 3) includes a processing device 404 and memory 412. Computing device 400 may include one or more microprocessors, microcontrollers or any such devices for accessing memory 412 (also referred to as a non-transitory media) and hardware 422. Computing device 400 has processing capabilities and memory suitable to store and execute computer-executable instructions.

Computing device 400 executes instructions stored in memory 412, and in response thereto, processes signals from hardware 422. Hardware 422 may include an optional display 424, an optional input device 426 and an I/O communications device 428. I/O communications device 428 may include a network and communication circuitry for communicating with network 304, 310 or an external memory storage device.

Optional Input device 426 receives inputs from a user of the computing device 400 and may include a keyboard, mouse, track pad, microphone, audio input device, video input device, or touch screen display. Optional display device 424 may include an LED (Light Emitting diode), LCD (Liquid Crystal display), CRT (Cathode Ray Tube) or any type of display device to enable the user to preview information being stored or processed by computing device 404.

Memory 412 may include volatile and nonvolatile memory, removable and non-removable media implemented in any method or technology for storage of information, such as computer-readable instructions, data structures, program modules or other data. Such memory includes, but is not limited to, RAM (Random Access Memory), ROM (Read Only Memory), EEPROM (Electrically Erasable Programable Read only memory), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computer system.

Stored in memory 412 of the computing device 400 may include an operating system 414, a deduplication system application 420 and a library of other applications or database 416. Operating system 414 may be used by application 420 to control hardware and various software components within computing device 400. The operating system 414 may include drivers for device 400 to communicate with I/O communications device 428. A database or library 418 may include preconfigured parameters (or set by the user before or after initial operation) such a server operating parameter, server libraries, HTML (HyperText Markup Language) libraries, API's and configurations. An optional graphic user interface or command line interface 423 may be provided to enable application 420 to communicate with display 424.

Application 420 may include a receiver module 430, a partitioner module 432, a hash value creator module 434, determiner/comparer module 438 and a storing module 436.

The receiver module 430 includes instructions to receive one or more files via the network 304 from the remotely disposed computing device 302. The partitioner module 432 includes instructions to partition the one or more received files into one or more data objects. The hash value creator module 434 includes instructions to create one or more hash values for the one or more data objects. Exemplary algorithms to create hash values for the one or more data objects include, but are not limited to, MD2(Message-Digest Algorithm), MD4, MD5, SHA1(Secure Hash Algorithm), SHA2, SHA3, RIPEMD (RACE Integrity Primitives Evaluation Message Digest), WHIRLPOOL (cryptographic hash function designed by Vincent Rijmen and Paulo S. L. M. Barreto,), SKEIN (Hash function designed by Niels Ferguson-Stefan Lucks-Bruce Schneier-Doug Whiting-Mihir Bellare-Tadayoshi Kohno-Jon Callas-Jesse Walker), Buzhash (rolling hash function), Cyclic Redundancy Checks (CRCs), CRC32, CRC64, and Adler-32(checksum algorithm which was invented by Mark Adler).

The determiner/comparer module 438 includes instructions to determine, in response to a receipt from a networked computing device (e.g. device hosting application 302) of one of the one or more additional files that include one or more data objects, if the one or more data objects are identical to one or more data objects previously stored on the one or more remotely disposed storage systems (e.g. device 312) by comparing one or more hash values for the one or more data objects against one or more hash values stored in one or more records of the storage table.

The storing module 436 includes instructions to store the one or more data objects on one or more remotely disposed storage systems (such as remotely disposed computing device 312 using API 311) at one or more location addresses, and instructions to store in one or more records of a storage table, for each of the one or more data objects, the one or more hash values and a corresponding one or more location addresses. The storing module also includes instructions to store in one or more records of the storage table for each of the received one or more data objects if the one or more data objects are identical to one or more data objects previously stored on the one or more remotely disposed storage systems (e.g. device 312), the one or more hash values and a corresponding one or more location addresses of the received one or more data objects, without storing on the one or more remotely disposed storage systems (device 312) the received one or more second data objects identical to the previously stored one or more data objects.

Illustrated in FIGS. 5 and 6, are exemplary processes 500 and 600 for deduplicating storage across a network. Such exemplary processes 500 and 600 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes are described with reference to FIG. 4, although it may be implemented in other system architectures.

Referring to FIG. 5, a flowchart of process 500 executed by a deduplication application 420 (See FIG. 4) (hereafter also referred to as “application 420”) is shown. In one implementation, process 400 is executed in a computing device, such as intermediate computing device 308 (FIG. 3). Application 420, when executed by the processing devices, uses the processor 404 and modules 416-438 shown in FIG. 4.

In block 502, application 420 in computing device 308 receives one or more files via network 304 from a remotely disposed computing device (e.g. device hosting application 302).

In block 503, application 420 divides the received files into data objects, creates hash values for the data objects, and stores the hash values into a storage table in memory on intermediate computing device (e.g. an external computing device, or system 312).

In block 504, application 420 stores the one or more files via the network 310 onto a remotely disposed storage system 312 via API 311.

In block 505, optionally an API within system 312 stores within records of the storage table disposed on system 312 the hash values and corresponding location addresses identifying a network location within system 312 where the data object is stored.

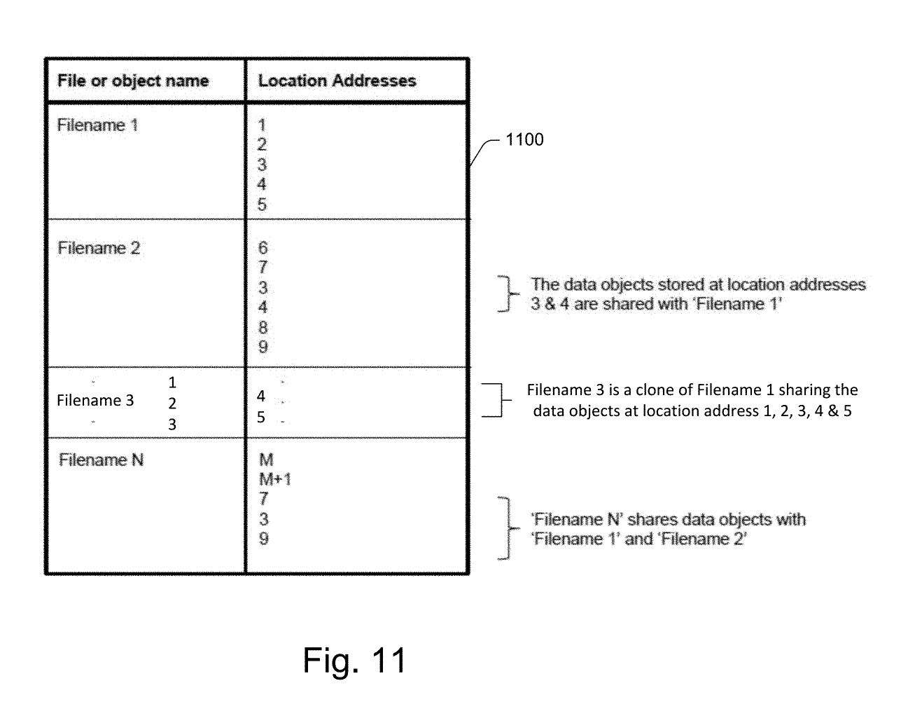

In block 518, application 420 stores in one or more records of a storage table disposed on the intermediate device 308 or a secondary remote storage system (not shown) for each of the one or more data objects the one or more hash values and a corresponding one or more network location addresses. Application 420 also stores in a file table (FIG. 11) the names of the files received at in block 502 and the location addresses created at block 505.

In one implementation, the one or more records of a storage table are stored for each of the one or more data objects the one or more hash values and a corresponding one or more location addresses of the data object without storage of an identical data object on the one or more remotely disposed storage systems. In another implementation, the one or more hash values are transmitted to the remotely disposed storage systems for storage with the one or more data objects. The hash value and a corresponding one or more new location addresses may be stored in the one or more records of the storage table. Also the one or more data objects may be stored on one or more remotely disposed storage systems at one or more location addresses with the one or more hash values.

In block 520, application 420 receives from the networked computing device another of the one or more files.

In block 522, in response to the receipt from a networked computing device of another of the one or more files including one or more data objects, application 420 determine if the one or more data objects were previously stored on one or more remotely disposed storage systems 312 by comparing one or more hash values for the data object against one or more hash values stored in one or more records of the storage table.

In block 524, application 420 stores the one or more data objects of the file, which were not previously stored, on one or more remotely disposed storage systems (e.g. device 312) at the one or more location addresses.

In one implementation, the application 420 may deduplicate data objects previously stored on any storage system by including instructions that read one or more files stored on the remotely disposed storage system, divide the one or more first files into one or more data objects, and create one or more hash values for the one or more data objects. Once the first hash values are created, application 420 may store the one or more data objects on one or more remotely disposed storage systems at one or more location addresses, store in one or more records of the storage table, for each of the one or more data objects, the one or more hash values and a corresponding one or more location addresses, and in response to the receipt from the networked computing device of the another of the one or more files including the one or more data objects, determine if the one or more data objects were previously stored on one or more remotely disposed storage systems by comparing one or more hash values for the data object against one or more hash values stored in one or more records of the storage table. The filenames of the files are stored in the file table (FIG. 11) along with the location addresses of the duplicate data objects (from the first files) and the location addresses of the unique data objects from the files.

Referring to FIG. 6, there is shown an alternate embodiment of system architecture diagram illustrating a process 600 for storing data objects with deduplication. Process 600 may be implemented using an application 420 in intermediate computing device 308 shown in FIG. 3.

In block 602, the process includes an application (such as application 420) that receives a request to store an object (e.g., a file) from a client (e.g., the “Client System” in FIG. 1). The request typically consists of an object key which names the object (e.g., like a filename), the object data (a stream of bytes) and some metadata.

In block 604, the application splits the stream of data into data objects, using a block splitting algorithm. In one implementation, the block splitting algorithm could generate variable length blocks such as an algorithm described in the U.S. Pat. No. 5,990,810 or, could generate fixed length blocks of a predetermined size, or could produce data objects that have a high probability of matching already stored data objects. When a data object boundary is found in the data stream, a data object is emitted to the next stage. The data object could be almost any size.

In block 606, each data object is hashed using a cryptographic hash algorithm like MD5, SHA1 or SHA2 (or one of the other hash algorithms previously mentioned). Preferably, the constraint is that there must be an extremely low probability that the hashes of different data objects are the same.

In block 608, each data block hash is looked up in a table mapping data object hashes that have already been encountered to data object locations in the cloud object store (e.g. a hash-to-location table). If the hash is found, then that block location is recorded, the data object is discarded and block 612 is run. Optionally if the hash is not found in the table, then the data object is compressed in block 610 using a lossless text compression algorithm (e.g., algorithms described in U.S. Pat. No. 5,051,745, or U.S. Pat. No. 4,558,302, the contents of which are hereby incorporated by reference).

In block 612, the data objects may be aggregated into a sequence of larger aggregated data objects to enable efficient storage. In block 614, the data objects (or aggregate data objects) are then stored into the underlying object store 618 (the “cloud object store” 312 in FIG. 3). When stored, the data objects are ordered by naming them with monotonically increasing numbers in the object store 618.

In block 616, after the data blocks are stored in the cloud object store 618, the hash-to-location table is updated, adding the hash of each block and its location in the cloud object store 618.

The hash-to-location table (referenced here and in block 608) is stored in a database (e.g. database 620) that is itself stored on a fast, unreliable, storage device directly (e.g., a Solid State Disk, Hard Drive, RAM) attached to the computer receiving the request. The data object location takes the form of either the number of the aggregate data object stored in block 614, the offset of the data object in the aggregate, and the length of the data object; or, the number of the data object stored in block 614.

In block 616, the list of locations from blocks 608-614 may be stored in along with the object key in the key-to-location-list (key namespace) table in a database also stored on a fast, unreliable, storage device directly attached to the computer receiving the request. Preferably the key and data object locations are stored into the cloud object store 618 using the same monotonically increasing naming scheme as the data objects.

The process may then revert to block 602, in which a response is transmitted to the client device (mentioned in block 602) indicating that the file has been stored.

Illustrated in FIG. 7, is exemplary process 700 implemented by the client application 302 (See FIG. 3) for deduplicating storage across a network. Such exemplary process 700 may be a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to FIG. 3, although it may be implemented in other system architectures.

In block 702, client application 302 prepares a request for transmission to intermediate computing device 308 to store an object (e.g. a file). The request typically consists of an object key which names the object (e.g., like a filename), the object data (a stream of bytes) and some metadata. In block 704, client application 302 transmits the request to intermediate computing device 308 to store a file.

In block 706, the request is received by 306 and process 500 or 600 is executed by device 308 to store the file. In block 708, the client application receives a response notification from the intermediate computing system indicating the file has been stored.

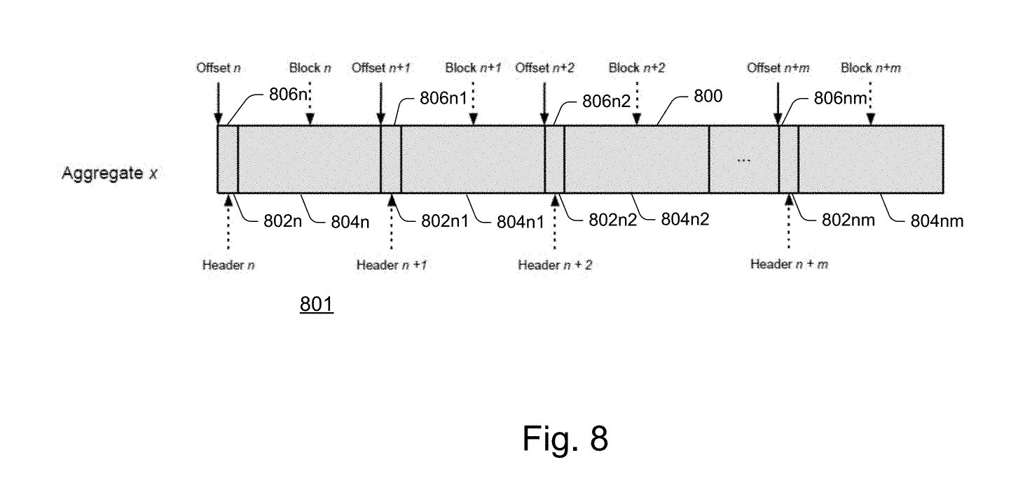

Referring to FIG. 8, an exemplary aggregate data object 801 as produced by block 612 in FIG. 6 is shown. The data object includes a header 802n-802nm, with a block number 804n-804nm and an offset indication 806n-806nm (as described in connection with FIG. 7), and includes a data block.

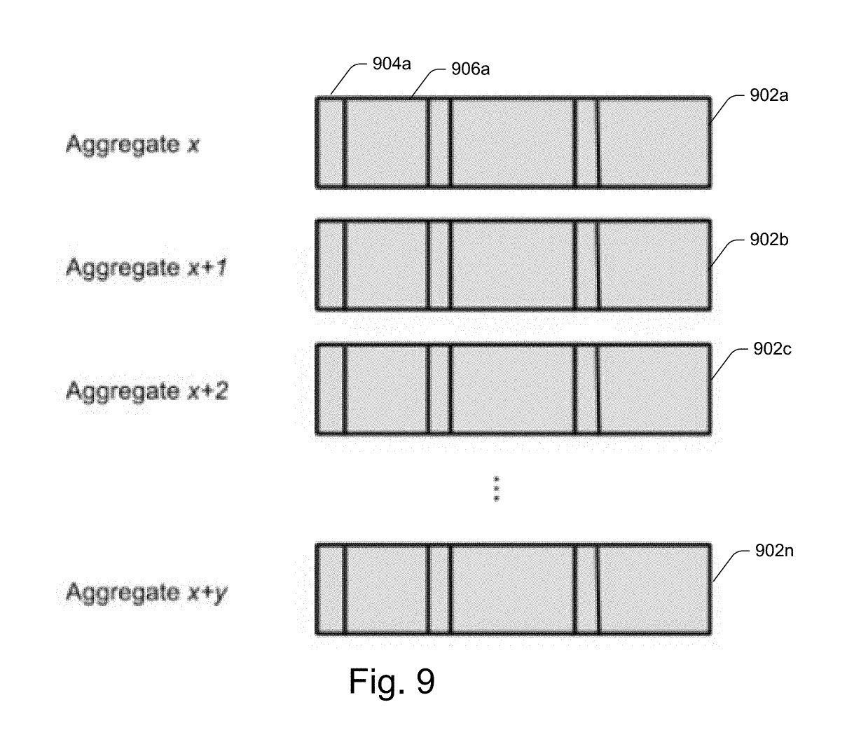

Referring to FIG. 9, an exemplary set of aggregate data objects 902a-902n for storage in memory is shown. The data objects 902a-902n each include the header (e.g. 904a) (as described in connection with FIG. 8) and a data block (e.g. 906a).

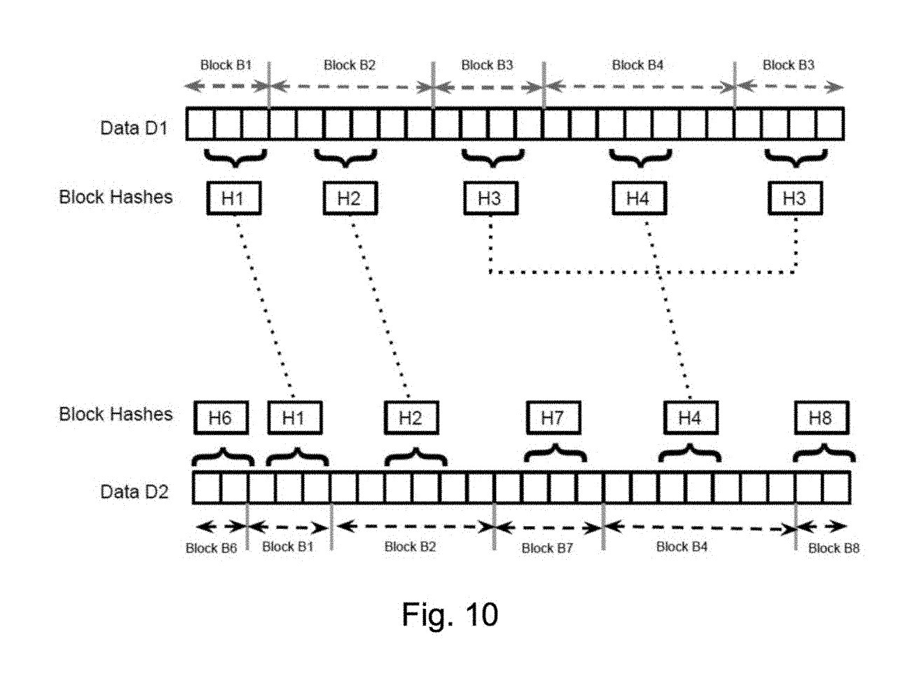

Referring to FIG. 10, an exemplary relation between the hashes (which are stored in a separate deduplication table) and two separate data objects are shown. Portions within blocks of data object D1 are shown with hashes H1-H4, and portions within blocks of data object D2 are shown with hashes H1, H2, H4, H6, H7, and H8. It is noted that portions of data objects having the same hash value are only stored in memory once with its location of storage within memory recorded in the deduplication table along with the hash value.

Referring to FIG. 11, a table 1100 is shown with filenames (“Filename 1”-“Filename N”) of the files stored in the file table along with their data objects for the files' network location addresses. Exemplary data objects of Filename 1 are stored at network location address 1-5. Exemplary data objects of Filename 2 are stored at location address 6, 7, 3, 4, 8 and 9. The data objects of “Filename 2” are stored at location address 3 and 4 are shared with “Filename 1”. “Filename 3” is a clone of “Filename 1” sharing the data objects at location addresses 1, 2, 3, 4 & 5. “Filename N” shares data objects with “Filename 1” and “Filename 2” at location addresses 7, 3 and 9.

Referring to FIG. 12, there is shown an exemplary process 1200 for writing/uploading new objects (e.g. files) using an intermediary computing device 306 or 400 shown in FIGS. 3 and 4. In process 1200, a series of data objects will be uploaded to the remotely disposed storage system (such as an object store) one or more of which may be replicated to a second remotely disposed storage system.

The system (a program running on computing device 306 in FIG. 3) receives a request to store an object (e.g., a file) from a client 302. The request consists of an object key (analogous to a filename), the object data (a stream of bytes) and meta-data. In block 1202, the program will perform deduplication as described previously in connection with FIGS. 1-11, upon the data by splitting the data into data objects and checking whether each data object is already present in the system. For each unique data object, the data object is stored into the Cloud Object Store, and index information is stored into a hash-to-location table 1203.

The supplied object key is checked in block 1204 to see if the key already exists in the key-to-location table 1205.

In block 1206, the location addresses for the data objects identified in the deduplication process are stored against the object key in the key-to-locations table 1205.

In block 1208, a record of the object key and the corresponding location addresses is sent to the cloud object store 1207 (312 in FIG. 3), using the same naming scheme as the data objects.

A response is the sent in block 1210 to the client 302 indicating that the object (e.g. file) has been stored.

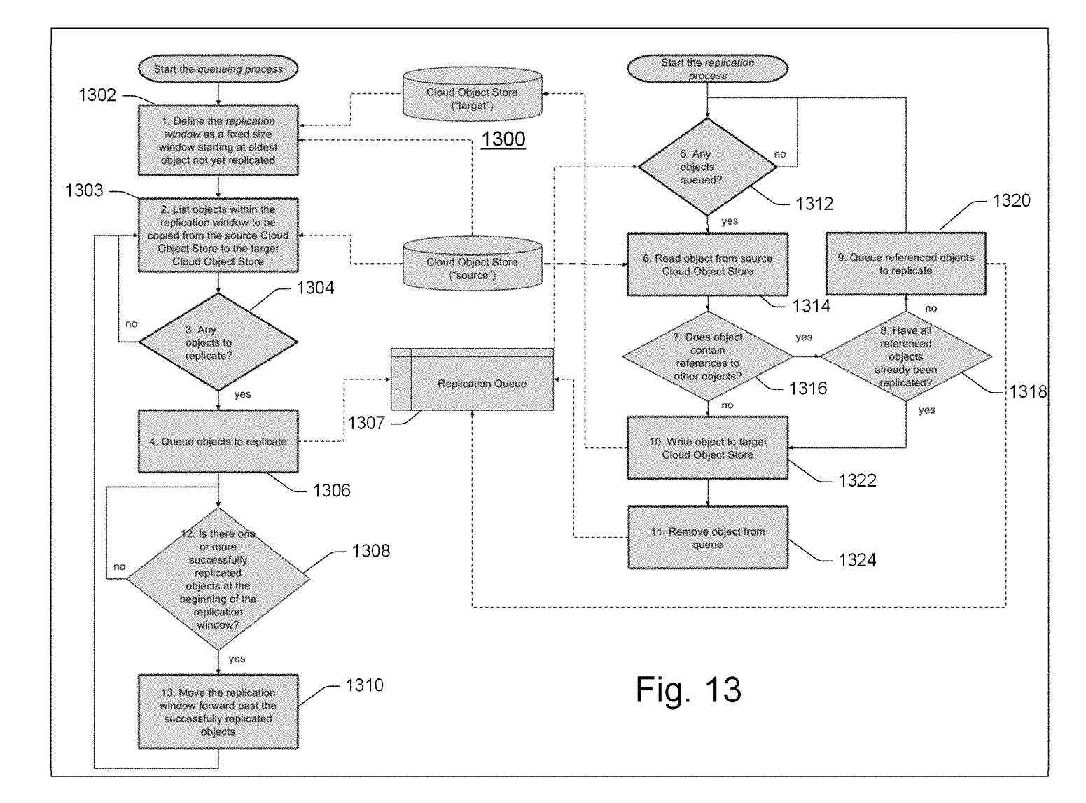

Referring to FIG. 13, there is shown an exemplary process 1300 for replicating (copying) the data that is created, modified and deleted from one Cloud Object Store (the source) to another Cloud Object Store (the target) using an intermediary computing device 308 or 400 shown in FIGS. 3 and 4. The system starts two parallel processes the queueing process and the replication process.

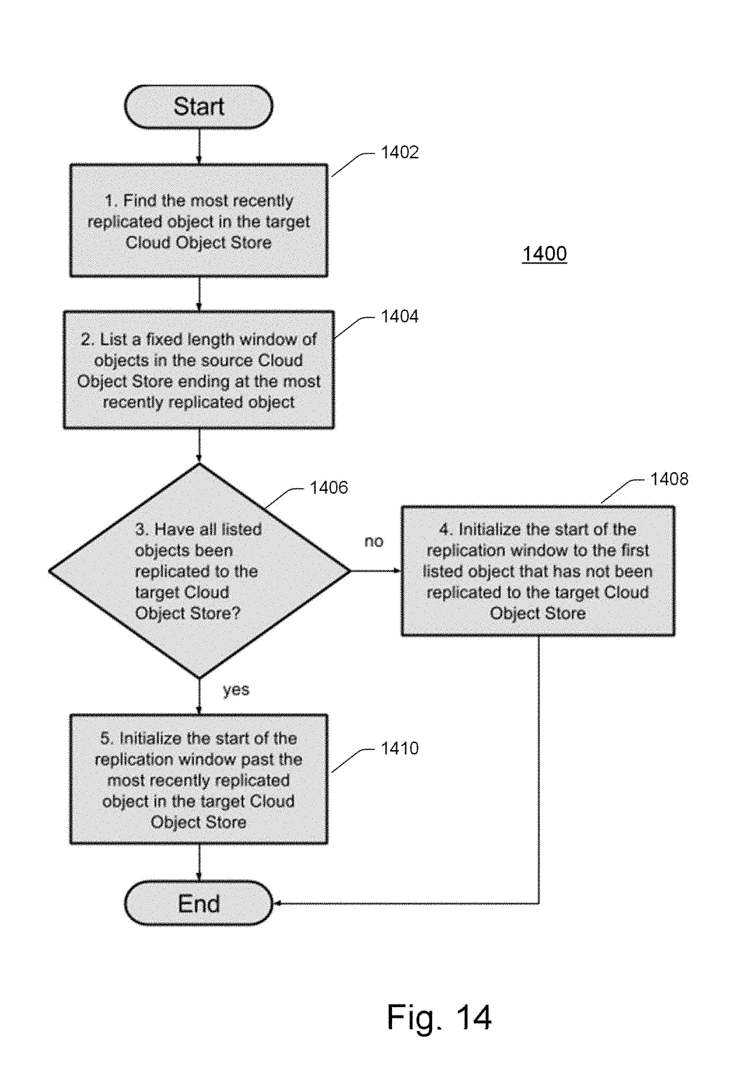

In block 1302, the queueing process defines a replication window as a fixed size window starting at the oldest object that exists in the source Cloud Object Store that does not exist in the target Cloud Object Store. An example of how this process might be implemented can be found in FIG. 14.

In block 1303, the queueing process lists data objects within the replication window from the source Cloud Object Store that are to be written to the target Cloud Object Store.

In block 1304, a determination is made as to whether one or more data objects were listed within the replication window on the source Cloud Object Store. If the one or more data objects were listed, then these data objects must be replicated to the target Cloud Object Store in block 1306, otherwise block 1303 is repeated.

In block 1306, the queueing process adds the names of the data objects listed within the replication window to replication queue 1307.

In block 1308, the queuing process observes the successful replication of data objects to be replicated. If one or more data objects to be replicated were successfully replicated at the beginning of the replication window then continue to block 1310, otherwise block 1308 is repeated.

In block 1310, the queuing process moves the replication window past the successfully replicated data objects and moves to block 1303.

### Replication Process

In block 1312, the replication process begins by checking if one or more objects exist within the replication queue. If such objects exist, process continues to block 1314, otherwise block 1312 is repeated.

In block 1314, the replication queue process reads a data object to be replicated from the source Cloud Object Store.

In block 1316, the replication process inspects the data object to be replicated to determine if the data object contains references to other data objects within the source Cloud Object Store. If the data object contains references to other data objects block 1318 is executed, otherwise block 1322 is executed.

In block 1318, the replication process determines if all data objects referenced by the data to be replicated have previously been replicated. If one or more referenced objects have not previously been replicated, block 1320 is executed, otherwise block 1322 is executed.

An example of references between data objects are those created during a Garbage Collection process (see U.S. Provisional Patent Application No. 62/427,353 filed Nov. 29, 2016). During the compaction process one or more compaction maps are stored to a new data object in the source Cloud Object Store. Each compaction map contains references to other data objects that the compaction process modified or deleted. When replicating the data object containing a compaction map the replication process must replicate the data objects the compaction map indicates were modified to the target Cloud Object Store, and delete the data objects in the target Cloud Object Store the compaction map indicates have been deleted in the source Cloud Object Store.

Data objects may be replicated using a scale-out cluster of servers. A scale-out cluster spreads the data objects, index information and deduplication processing load across an arbitrary number of servers arranged in a cluster.

Data deduplication using a scale-out cluster works in a similar way to that described in the “DATA CLONING SYSTEM AND PROCESS” U.S. patent application Ser. No. 15/600,641, filed May 19, 2017, the contents of which is hereby incorporated by reference.

In a scale-out cluster the data storage tables are divided into shards. Each shard is responsible for storing a portion of the data storage table namespace and at the end of the deduplication and/or garbage collection processes stores data objects into a Cloud Object Store. Shards may each store data objects to a unique object namespace within a common Cloud Object Store, to different Cloud Object Stores, or a combination of both.

Referring to FIG. 13, In block 1320, the replication process adds the names of the referenced objects to the replication queue.

In block 1322, the replication process writes the data object to be replicated to the target Cloud Object Store.

In block 1324, the replication process removes the data object to be replicated from the replication queue now that it has successfully replicated the data object from the source Cloud Object Store to the target Cloud Object Store.

Referring to FIG. 14, there is shown a process 1400 to inspect the source Cloud Object Store and the target Cloud Object Store to determine the starting position of the replication window. The replication window is a sliding window that represents the data objects to be replicated from the source Cloud Object Store to the target Cloud Object Store at a point in time. The replication window requires a data object naming convention that allows for data objects to be listed in the order they were written to the source Cloud Object Store in by the system e.g. monotonically increasing data object names.

In block 1402, the system finds the newest (highest ordered) replicated data object in the target Cloud Object Store. One way of finding this object may be to use a binary search on top of the Cloud Object Store API.

In block 1404, the system lists a fixed length window of data objects in the source Cloud Object Store, ending at the data object listed in block 1402.

In block 1406, the system checks if each data object listed from the source Cloud Object Store in block 1404 exists in the target Cloud Object Store. If all listed data objects exist in the source Cloud Object Store and the target Cloud Object Store, the process continues by executing block 1408, otherwise block 1410 is executed.

In block 1408, the process initializes the start of the replication window to the first listed data object that has not previously been replicated to the target Cloud Object Store.

In block 1410, the process initializes the start of the replication window past the newest replicated data object in the target Cloud Object Store.

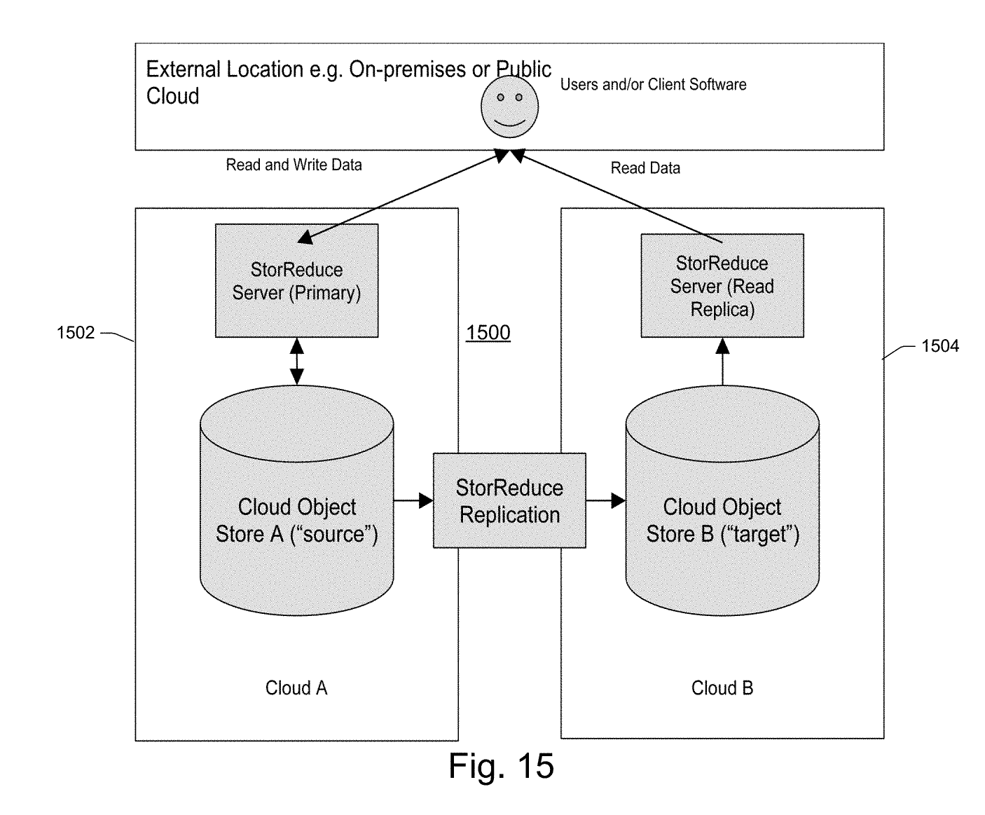

Referring to FIG. 15, there is shown a scenario 1500 to maintain two copies of the data objects on different Cloud Object Stores for the purposes of disaster recovery. If the data objects in one Cloud Object Store should become inaccessible the data objects in the second Cloud Object Store should remain accessible.

Replication is configured to replicate from Cloud Object Store A (the “source”) 1502 to Cloud Object Store B (the “target”) 1504. Replication continuously ensures the data objects in the target are up to date with the data objects from the source. Users and Client Software can read and write files to the source location, and can read the files from the target location when necessary. To facilitate this, a secondary server (“read replica”) runs continuously to provide read access to the data objects and index (data storage table) in the target Cloud Object Store.

This example scenario may be used in the event of a Cloud Object Store outage. Outages typically affect only one Cloud Provider and Cloud Object Store, while other Cloud Providers and Cloud Object Stores remain operational. During an outage, user and client software can still access the files in the second Cloud Object Store.

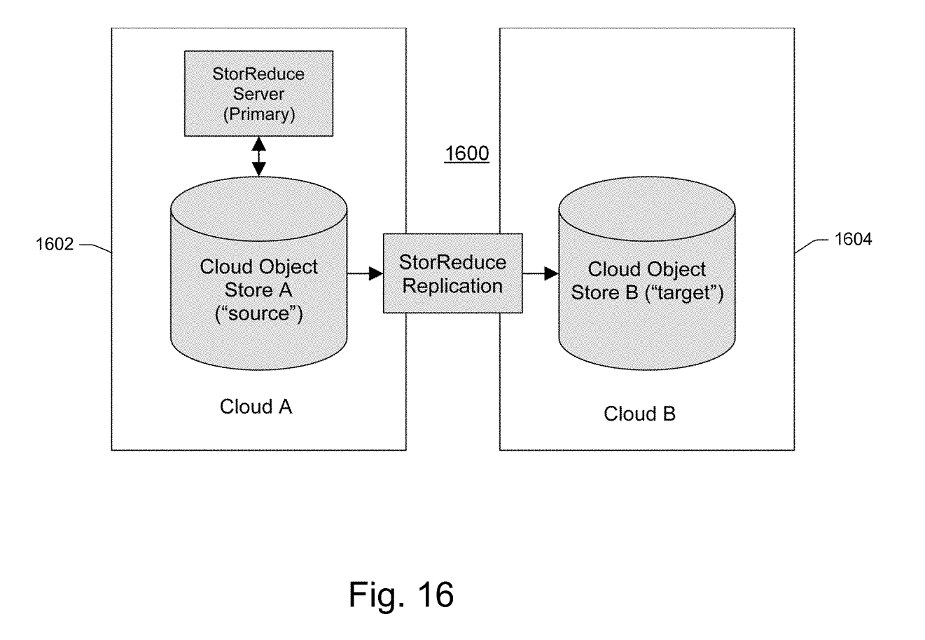

Referring to FIG. 16, in this scenario 1600, two copies of the data objects are maintained on different Cloud Object Stores (Cloud object store 1602 and 1604) for the purposes of regulatory compliance. The second copy of the data objects must be maintained and kept up to date, but does not need to be immediately available if access to the source data objects is temporarily lost.

An example of this scenario is to comply with HIPAA (Health Insurance Portability and Accountability Act of 1996, United States), which states that there must be accessible backups of electronic Protected Health Information and procedures to restore lost data in the event of an emergency. The data objects in the target Cloud Object Store provide accessible backups of electronic Protected Health Information.

Another example is to comply with the Sarbanes Oxley Act which requires that certain electronic records be archived for up to 7 years. To ensure that organizations remain compliant it is best practice to store two copies of archived data, in case one copy is accidentally lost or destroyed. The data objects in the target Cloud Object Store provide a second copy.

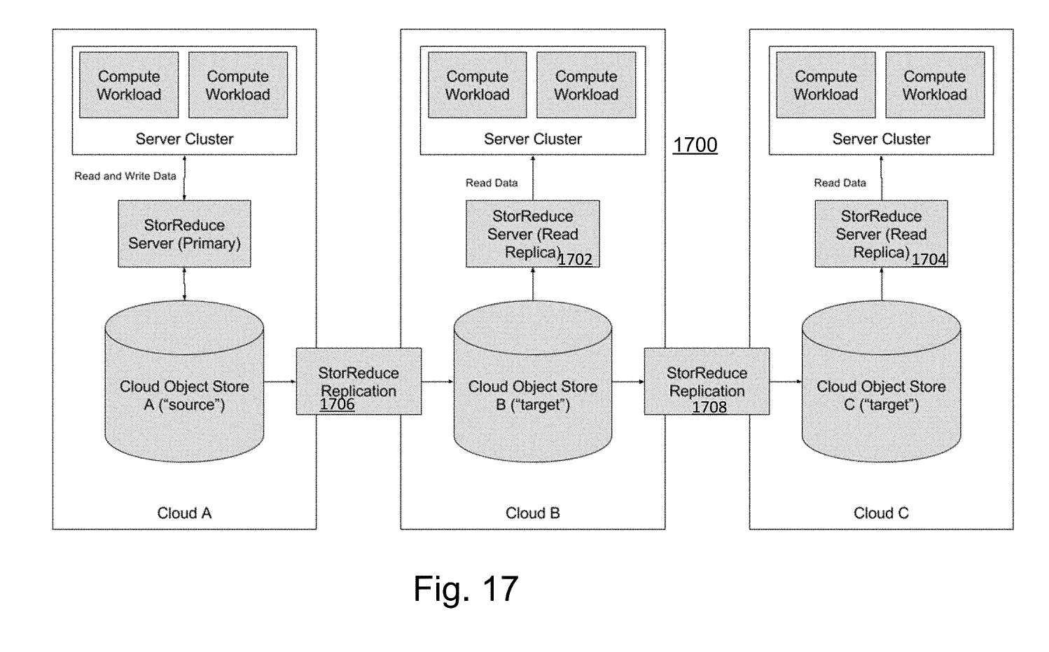

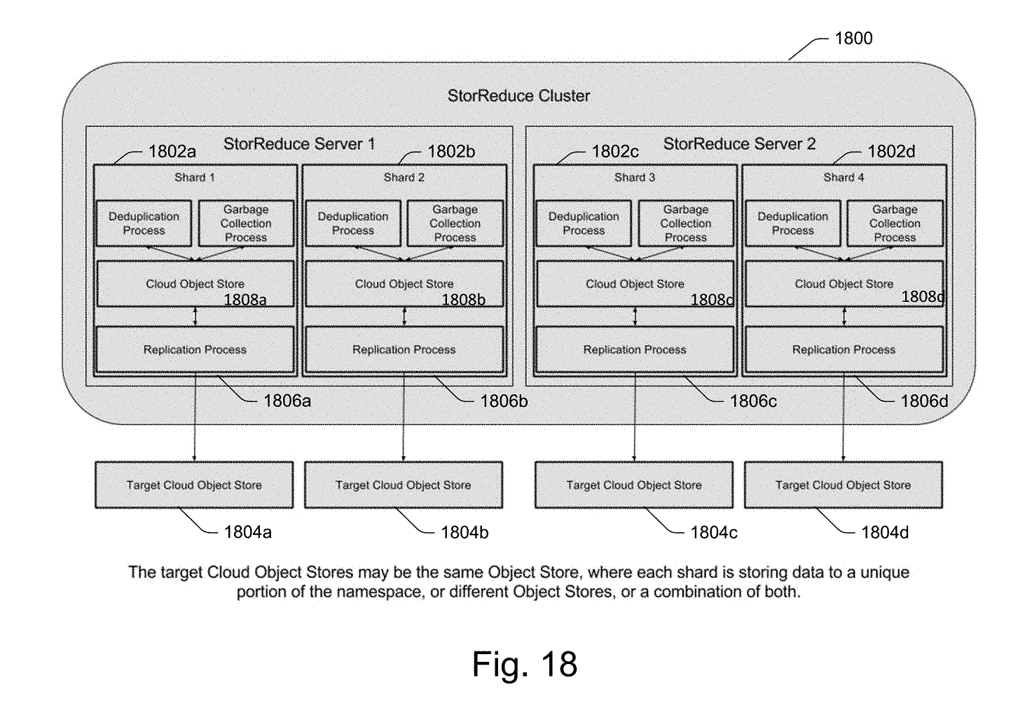

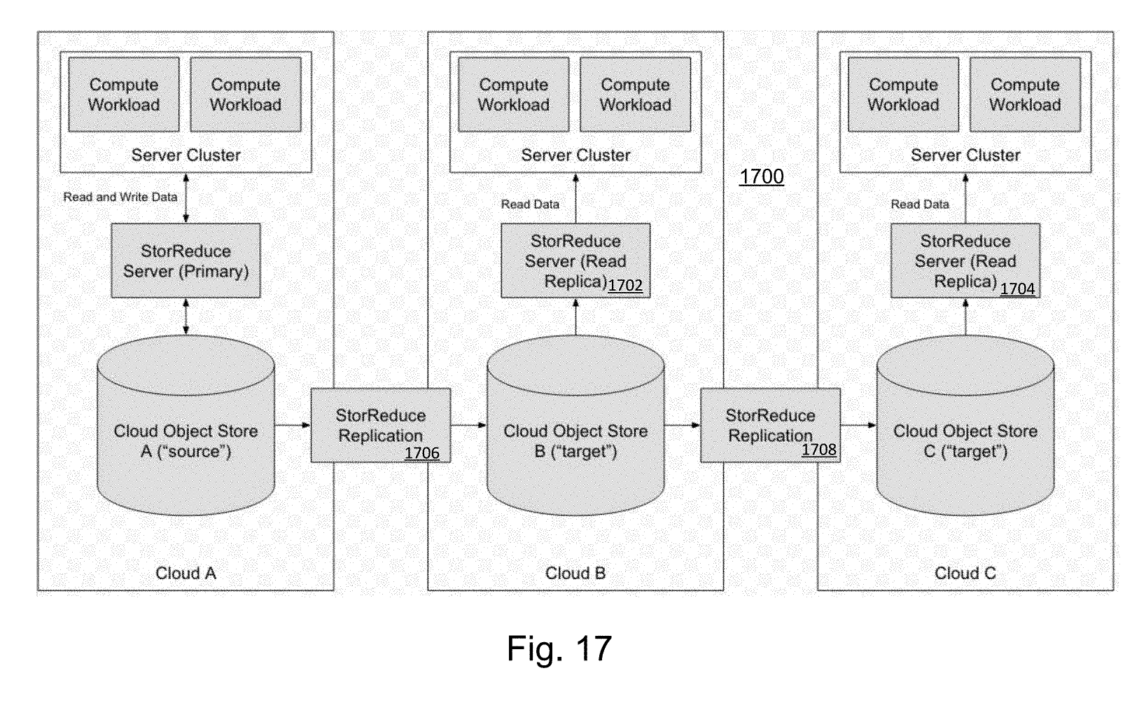

Referring to FIG. 17, there is shown scenario 1700, where it is desired to maintain two or more copies of the data objects in different physical locations, for the purposes of making the data objects available via high bandwidth and low latency local connections to compute workloads in geographically diverse locations.

An example of this scenario is where the data objects are being written or read by a server cluster via a primary server in a primary location (Cloud A), and a big data process such as map reduce or search indexing must be run over the corresponding files. That process can run in a secondary location (Cloud B) using the replication process 1702 and a third location (Cloud C) using another replication process 1704 where spot pricing may make the compute resources cheaper than in the primary location. Cloud Object Store A may be replicated into Cloud Object Store B using Replication process 1706, and may be replicated into Cloud Object Store C using replication process 1708. These processes require high bandwidth, low latency access to the data objects and corresponding files.

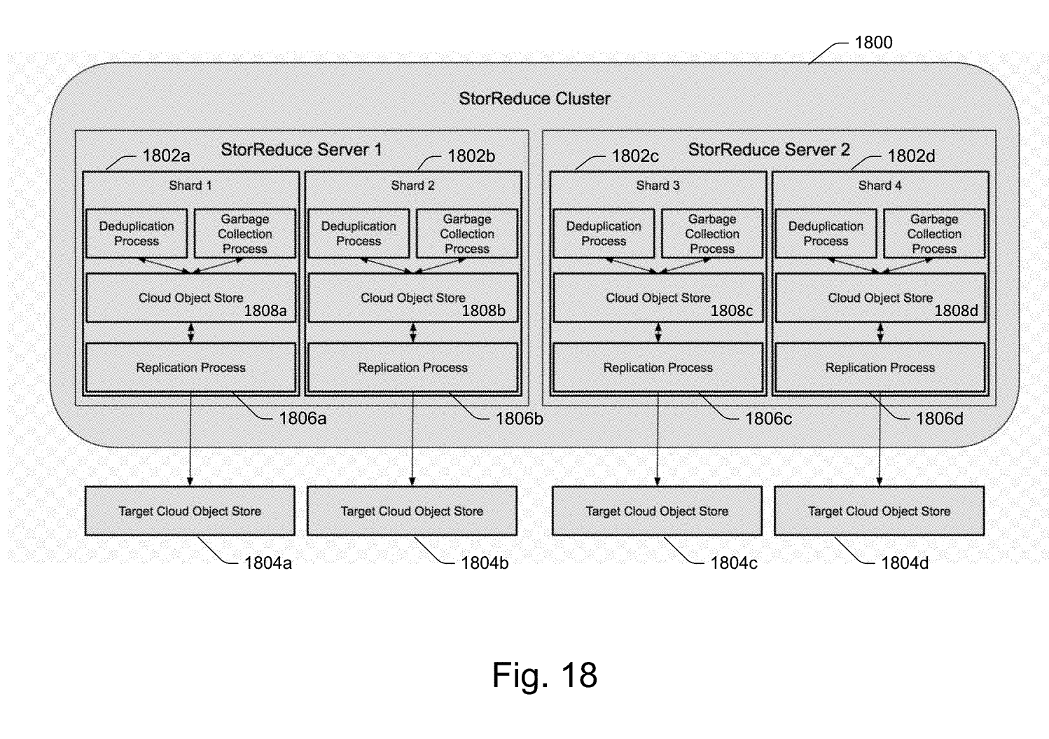

Referring to FIG. 18, in a scale-out cluster 1800 (where multiple replication processes are run simultaneously) a replication process 1806a-1806d remains the same as described herein; however, one replication process 1806a-1806d is run per shard 1802a-1802d. Target Cloud Object Stores 1804a-1804d may be the same Object Store 1808a-1808d, where each shard 1802a-1802d is storing data to a unique portion of the namespace, or different Object Stores, or a combination of both.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A processing device to replicate one or more files stored on segregated remotely disposed computing devices comprising:
circuitry to receive one or more files via a network from a remotely disposed computing device;
circuitry to partition the one or more received files into one or more data objects;
circuitry to create one or more hash values for the one or more data objects;
circuitry to store the one or more data objects on a first remotely disposed storage system at one or more first location addresses;
circuitry to store in one or more records of a first storage table, for each of the one or more data objects, the one or more hash values and the one or more first location addresses;
circuitry to receive an indication to replicate one or more of the stored data objects onto a second remotely disposed storage system; and
circuitry, responsive to the indication to replicate, to replicate the one or more stored data objects onto the second remotely disposed storage system by copying the indicated data objects from the first remotely disposed storage system to the second remotely disposed storage system.

2. The processing device of claim 1, wherein the one or more records of the first storage table corresponding to the data objects on the first object store are stored on a first remotely located storage system, and wherein the one or more records of the second storage table corresponding to the data objects on the second object store are stored on a second remotely located storage system.

3. The processing device of claim 1, further comprising circuitry, in response to a replicating of the indicated data objects, for copying or recreating the one or more records corresponding to the replicated data objects in a second storage table on the second remotely located storage system.

4. The processing device of claim 1, wherein the one or more records includes at least one of hash values, one or more location addresses, one or more key-to-location records, or one or more file tables, or meta data.

5. The processing device of claim 1, wherein the network includes at least one of a Local Area Network, an Ethernet Wide Area Network, an Internet Wireless Local Area Network, an IEEE 802.11g standard wireless network, a WiFi network, a Wireless Wide Area Network, or a telecommunications network.

6. The processing device of claim 1, wherein protocols are executed on the network, wherein the protocols include TCP, UDP, IP, GSM, WiMAX, LTE, HDLC, Frame Relay and ATM.

7. The processing device of claim 1, wherein each of the one or more remotely disposed storage systems includes at least one of: an IBM Cloud Object Store, an OpenStack Swift, an EMC Atmos, a Cloudian HyperStore, a Scality RING, an Hitachi Content Platform, an HGST Active Archive, an Amazon® S3 service, a Microsoft® Azure Blob service, a Google® Cloud Storage service, and a Rackspace® Cloud Files service.

8. The processing device of claim 1, wherein the circuitry, responsive to the indication to replicate, to replicate the one or more stored data objects onto the second remotely disposed storage system by copying the indicated data objects from the first remotely disposed storage system to the second remotely disposed storage system via a wide area network.

9. The processing device of claim 1, wherein the circuitry to create one or more hash values for the one or more data objects uses at least one of MD2, MD4, MD5, SHA1, SHA2, SHA3, RIPEMD, WHIRLPOOL, SKEIN, Buzhash, Cyclic Redundancy Checks (CRCs), CRC32, CRC64, and Adler-32 hashing algorithms.

10. The processing device of claim 1, wherein the replicated data objects that contain references to other data objects are replicated from the first object store to the second object store.

11. The processing device of claim 1, wherein the replicated data objects at least one of unique file data, metadata pertaining to the file data and replication of files, user account information, directory information, access control information, security control information, garbage collection information, file cloning information, and references to other data objects.

12. A method to replicate one or more files of segregated remotely disposed computing devices with a processing device, the method comprising:
receiving one or more first files via a network from a first remotely disposed computing device;
partitioning the one or more received first files into one or more data objects;
creating one or more hash values for the one or more data objects;
storing the one or more data objects on a first remotely disposed storage system at one or more first location addresses;
storing in one or more records of a first storage table, for each of the one or more data objects, the one or more hash values and the one or more first location addresses;
receiving an indication to replicate at least a portion of one or more of the stored data objects onto a second remotely disposed storage system; and
responding to the indication to replicate by replicating a portion of the one or more of the stored data objects onto the second remotely disposed storage system by copying at least a portion of the indicated data objects from the first remotely disposed storage system onto the second remotely disposed storage system.

13. The method to replicate one or more files of claim 12, further comprising:
responding to the indication to replicate, by copying or creating, the one or more hash values, the one or more location addresses, and the one or more key-to-location records corresponding to the replicated data objects to store in one or more records of a second storage table on the second remotely located storage system.

14. The method to replicate one or more files of claim 12, further comprising:
responding to the indication to replicate by replicating another portion of the one or more of the received data objects onto another remotely disposed storage system by copying at least another portion of the data objects stored on the first remotely located storage system onto the another remoted located storage system simultaneously to the replication of the first portion of the one or more of the received data objects.

15. A computer readable storage medium storing one or more instructions for execution by a processor, the one or more instructions comprise:
instructions to receive one or more first files via a network from a first remotely disposed computing device;
instructions to partition the one or more received first files into one or more data objects;
instructions to create one or more hash values for the one or more data objects;
instructions to store the one or more data objects on a first remotely disposed storage system at one or more first location addresses;
instructions to store in one or more records of a first storage table, for each of the one or more data objects, the one or more hash values and the one or more first location addresses;
instructions to receive an indication to replicate one or more of the stored data objects onto a second remotely disposed storage system; and
instructions to respond to the indication to replicate by replicating the one or more of the stored data objects onto the second remotely disposed storage system by copying the indicated data objects from the first remotely disposed storage system onto the second remotely disposed storage system.

16. The computer readable storage medium of claim 15, wherein the one or more instructions, comprise:
instructions to after replicating the indicated data objects, copies or recreates the one or more hash values and the one or more location addresses and the one or more key-to-location records corresponding to the replicated data objects in a second storage table on the second remotely located storage system.
